(19) United States
(12) Patent Application Publication
(10) Pub. No.: US 2021/0313092 A1
(43) Pub. Date: Oct. 7, 2021

(54) POWER CABLES FOR ELECTRIC SUBMERSIBLE PUMP AND SYSTEMS AND METHODS THEREOF

(71) Applicant: PRYSMIAN S.p.A., Milano (IT)

(72) Inventors: Glenn GRABINSKY, Bridgewater, NJ (US); Edward WIENCEK, Bridgewater, NJ (US); Toma MILOUCHEV, Bridgewater, NJ (US); Giovanni Battista CALIMANI, Bridgewater, NJ (US)

(73) Assignee: PRYSMIAN S.p. A., Milano (IT)

(21) Appl. No.: 17/259,831

(22) PCT Filed: Jul. 13, 2018
(86) PCT No.: PCT/US2018/042056

§ 371 Date: Jan. 12, 2021

(51) Int. Cl. H01B 7/20; H01B 9/00; H01B 7/14

(52) U.S. Cl. CPC H01B 7/207; H01B 7/208; H01B 7/14; H01B 9/006

(57) ABSTRACT

A power cable (1) for an electric submersible pump (ESP) system, and systems and methods thereof are described herein. The power cable (12) is a weight-bearing three-phase power cable comprising a core (8) having an outer diameter and comprising three insulated conductors (2) substantially embedded in a polymeric bedding (3); and a multi-layered armor comprising an inner steel-based continuous tube (4) surrounding and in direct contact with the core (8), and an outer steel-based continuous tube (5) surrounding and in direct contact with the inner steel-based continuous tube (4). The inner steel-based continuous tube (4) and the outer steel-based continuous tube (5) are mechanical congruent with each other as a result of a roll reducing technique.

### BACKGROUND

The present disclosure relates to power cables for electric submersible pump (ESP) systems, and methods and systems thereof.

ESP systems can comprise both downhole and surface components. For example, downhole ESP system components can include a motor, one or more protectors, one or more pump sections, one or more pump intakes, one or more power cables, gas handling equipment, and one or more downhole sensors.

The ESP can be powered by a three-phase medium voltage (MV, between 1 kV and 35 kV) alternate current (AC), medium voltage (MV) power cable, for instance, which can be connected to an electrical supply and regulation system on the surface of the well. Generally, the power cable can be comprised of one or more electrical conductors and, optionally, at least one of one or more hydraulic lines, one or more data cables, one or more optical fibers, and one or more stranded ropes covered by respective one or more protecting layers.

ESP cables should be relatively small in diameter and, at the same time, mechanically robust, capable of supporting relatively large loads (or weights), while transporting AC current up to 200 A or more. ESP cables should also be relatively impervious to physical and electrical deterioration cause by aggressive or harsh well environments.

According to Stainless Steel Sensing Cable, AFL, Specialty Fiber Optic Cable, 2008 (www.AFLglobal.com), a stainless steel sensing cable provides a particular combination of size, robustness, and strength for temperature sensing applications, particularly in the context of installation in tunnels, roadways, airport runways, buried environments, gasifiers, and any industrial application where there is a need for crush resistance, high temperature performance and quick thermal response. Generally, the AFL stainless steel sensing cable comprises one optical fiber housed in a double tube or a triple tube configuration, where the tube material is either stainless steel 316L or Incoloy™ 825. The outer tube diameter is 0.125 inches (about 3 mm). The tube wall thickness is 0.016 inches (about 0.4 mm) for the double tube configuration and 0.024 inches (about 0.6 mm) for the triple tube configuration.

WO 2008/016353 relates to a method for creating a metallic tube product that includes creating a plurality of cylindrical members having different diameters from a plurality of flat metal strips, and creating a layered metal tube by embedding the plurality the cylindrical members within each other in order from smallest to largest, wherein the embedded cylindrical members are compression fit. The metal tubing includes a first tube containing optical fibers, and a second tube, wherein the inner diameter of the second tube is in intimate contact with the outer diameter of the first tube.

WO 2016/089717 relates to a power cable constructed to provide structural support of an electrical submersible pumping system. The power cable comprises at least one conductor and a plurality of layers selected and arranged, generally speaking, to ensure long-term support in the relatively harsh downhole environment. In particular, the power cable comprises an armor layer positioned around the outer jacket. The armor layer can be constructed of galvanized steel, stainless steel, or Monel™ strip, for instance. An additional armor layer or layers may be disposed atop a first armor layer.

US 2014/0102749 describes cables for supplying power to an electric submersible pump (ESP) that include a helically disposed electrical conductor, at least one polymer layer embedding the electrical conductor, and a seam-welded metallic tube drawn over the polymer layer. The seam-welded tube is drawn down until it fits tightly over the hard polymer layer insulating each conductor member. A gap or a soft polymer and/or a yarn layer is/are provided around the hard polymer layer.

U.S. Pat. No. 5,414,217 relates to electrical cable for use with submersible pumps used in oil wells. The electrical cable has a copper conductor core and an electrical insulation layer surrounding the conductor core. Each insulated conductor core has a polymeric, low permeable layer that surrounds the insulation layer. A metal tape layer preferably surrounds the lower permeable layer. The metal tape layer may be formed from stainless steel or Monel™, for instance. Double layers may be overlapped. Further, several insulated conductors constructed with the low permeable layer and the metal tape may be used in one cable, with an elastomeric jacket surrounding the metal tape of is each of the conductors. An outer metal armor comprised of steel strips are wrapped around the elastomeric jacket.

### SUMMARY

There is a need for a power cable operating an ESP system, in particular for the supply of power to the ESP, that is relatively small in outer diameter and, at the same time, mechanically robust, capable of supporting relatively large loads (or weights) with a life span longer, for example, than 5 years in the challenging environment of the downwell, especially at temperatures greater than 200° C. There is also a need for a power cable operating the ESP system to be relatively impervious to physical and chemical deterioration caused by aggressive or harsh well environments.

The Applicant has found that a mechanically robust power cable for ESP system, capable of bearing loads in rigless configuration (with no need of supporting tubing, even when used for retrieving the pump from the well) and with an increase in life span can be obtained by providing a power cable that has an armor as an outermost layer made of two or more longitudinally welded metal continuous tubes. Such multi-layered armor can fulfill mechanical and, optionally, corrosion resistant requirements, depending upon the environment for the power cable.

The multi-layered armor can be provided around a cable core, which may be comprised of a polymeric bedding that embeds electric conductor(s) and, optionally, hydraulic line(s), data cable(s), optical fiber(s), and/or stranded ropes covered by respective protecting layer(s).

In particular, the multi-layered armor comprises at least one inner and an outer continuous metal tube, each of the inner and outer metal continuous tubes can be separately provided around the cable core in the form of a foil longitudinally bent around, respectively, the polymeric bedding and the inner continuous tube (hereinafter both also being referred to as “the underlying layer”), and welded, to form a continuous tube having an inner diameter greater than the outer diameter of the underlying layer. After welding, each metal continuous tube can be reduced in diameter via a roll reducing technique so as to directly contact the underlying layer.

In the present description and claims, what is meant by the terms “roll reducing technique” or “roll reducing procedure” is a local deformation process during which the thickness of a tube remains substantially unchanged, the length increased, and the inner and outer diameters are decreased. The tube is pressed and advanced through rollers because friction pulls it into place as the rollers are turned.

In the present description and claims, as “tube diameters” it is meant both the inner and the outer diameter of the tube, unless further specified.

The roll reducing technique to reduce the tube diameters, in contrast to a drawing technique, was found particularly effective for bringing into intimate contact the outer continuous tube with the already roll-reduced inner continuous tube so as to make the inner and outer metal continuous tubes mechanically congruent with one another and act as a whole to support the weights of the power cable and the ESP (the total weight can customarily exceed 10 tons) and without stressing any of the continuous tubes to an extent potentially exceeding their tensile strength and bringing to a weakening or rupture thereof.

As used herein, “mechanically congruent” means that the roll-reduced metal continuous tubes withstand the strain substantially as a whole, so that they do not slide relative to each other even under substantial load.

In the present description and claims, as “continuous tube” is meant a tube with uninterrupted inner and outer surfaces, without passing-through apertures.

In the case of the inner continuous tube, the roll reducing technique is to reduce the tube diameters such that an inner diameter is substantially the same as an outer diameter of the cable core. In the case of the outer continuous tube, the rolling down technique is to reduce the tube diameters such that an inner diameter is substantially the same as the outer diameter of the inner continuous tube and to obtain a mechanical congruence between the inner and outer continuous tubes.

Thus, mechanically congruent multi-layer armor can be provided directly around the cable core to produce a resultant power cable that overcomes some or all of the problems discussed above.

As a non-limiting example, according to one or more embodiments of the disclosed subject matter, a weight-bearing three-phase power cable for an electric submersible pump (ESP) can comprise: a core having an outer diameter and comprising three insulated conductors substantially embedded in a polymeric bedding; and a multi-layered armor comprising an inner steel-based continuous tube surrounding and in direct contact with the core, and an outer steel-based continuous tube surrounding and in direct contact with the inner steel-based continuous tube. The outer steel-based continuous tube forms an outermost wall of the power cable.

The present power cable is configured to support its own weight and the weight of the ESP when coupled thereto.

As another example, one or more embodiments of the disclosed subject matter can involve a method of providing a three-phase medium voltage (MV) alternate current (AC) weight-bearing electric submersible pump (ESP) cable. The method can comprise: providing a cable core comprising a core comprising three insulated conductors substantially embedded in a polymeric bedding; providing an inner steel-based continuous tube in direct contact with the core, the inner steel-based continuous tube circumscribing the polymeric layer; and providing an outer steel-based continuous tube in direct contact with the inner steel-based continuous tube, the outer steel-based continuous tube circumscribing the inner steel-based continuous tube.

The present disclosure further relates to a method of providing a three-phase alternating current medium voltage weight-bearing electric submersible pump cable, the method comprising: providing a cable core with an outer diameter and comprising three insulated electrical conductors embedded in a polymeric bedding; providing around the cable core a first steel based foil; longitudinally folding the first steel based foil and welding at opposite edges thereof to form an inner steel-based continuous tube having an inner diameter greater the core outer diameter and an outer diameter; rolling down the inner steel-based continuous tube to bring it in direct contact with the cable core; providing around the inner steel-based continuous tube a second steel based foil; longitudinally folding the second steel based foil and welding at opposite edges thereof to form an outer steel-based continuous tube having an inner diameter greater the inner steel-based continuous tube and an outer diameter; rolling down the outer steel-based continuous tube to bring it in direct contact and mechanically congruent with the inner to steel-based continuous tube.

The inner steel-based continuous tube can have a first welding line and the outer steel-based continuous tube can have a second welding line in a position substantially diametrically opposed to that of the first welding line.

The inner steel-based continuous tube is in direct contact with the cable core is layer as a result of a first rolling down procedure reducing its diameter, the outer steel-based continuous tube is in direct contact with the inner steel-based continuous tube as a result of a second rolling down procedure reducing its diameter, and the outer steel-based continuous tube forms an outermost wall of the power cable.

In an embodiment, the present disclosure relates to an ESP system comprising: an electric submersible pump (ESP), a three-phase alternate current (AC) motor, and a power cable, the electric submersible pump, the three-phase AC motor, and the power cable being operatively connected, wherein the power cable is a weight-bearing three-phase power cable comprising: a core having an outer diameter and comprising three insulated conductors substantially embedded in a polymeric bedding, and a multi-layered armor comprising an inner steel-based continuous tube surrounding and in direct contact with the core, and an outer steel-based continuous tube surrounding and in direct contact with the inner steel-based continuous tube, wherein the inner steel-based continuous tube and the outer steel-based continuous tube are mechanical congruent with each other. The outer steel-based continuous tube forms an outermost wall of the power cable.

The preceding summary is to provide an understanding of some aspects of the disclosure. As will be appreciated, other embodiments of the disclosure are possible utilizing, alone or in combination, one or more of the features set forth above or described in detail below. Also, while the disclosure is presented in terms of exemplary embodiments, it should be appreciated that individual aspects of the disclosure can be separately claimed.

### BRIEF DESCRIPTION OF THE DRAWINGS

The accompanying drawings, which are incorporated in and constitute a part of the specification, are illustrative of one or more embodiments of the disclosed subject matter, and, together with the description, explain various embodiments of the disclosed subject matter. Further, the accompanying drawings have not necessarily been drawn to scale, and any values or dimensions in the accompanying drawings are for illustration purposes only and may or may not represent actual or preferred values or dimensions. Where applicable, some or all select features may not be illustrated to assist in the description and understanding of underlying features.

FIGS. 1a and 1b are schematic views of ESP system deployments that include a power cable according to one or more embodiments of the present disclosure.

FIG. 2 is a cross-sectional schematic view of a power cable according to an embodiment of the present disclosure.

FIG. 3 is a cross-sectional schematic view of a power cable according to another embodiment of the present disclosure.

FIG. 4 is a cross-sectional schematic view of a power cable according to yet another embodiment of the present disclosure.

FIG. 5 is a flow chart of a method according to one or more embodiments of the disclosed subject matter

### DETAILED DESCRIPTION

The description set forth below in connection with the appended drawings is intended as a description of various embodiments of the described subject matter and is not necessarily intended to represent the only embodiment(s). In certain instances, the description includes specific details for the purpose of providing an understanding of the described subject matter. However, it will be apparent to those skilled in the art that embodiments may be practiced without these specific details. In some instances, structures and components may be shown in block diagram form in order to avoid obscuring the concepts of the described subject matter. Wherever possible, the same reference numbers will be used throughout the drawings to refer to the same or the like parts.

Any reference in the specification to “one embodiment” or “an embodiment” means that a particular feature, structure, characteristic, operation, or function described in connection with an embodiment is included in at least one embodiment. Thus, any appearance of the phrases “in one embodiment” or “in an embodiment” in the specification is not necessarily referring to the same embodiment. Further, the particular features, structures, characteristics, operations, or functions may be combined in any suitable manner in one or more embodiments, and it is intended that embodiments of the described subject matter can and do cover modifications and variations of the described embodiments.

It must also be noted that, as used in the specification, appended claims and abstract, the singular forms “a,” “an,” and “the” include plural referents unless the context clearly dictates otherwise. That is, unless clearly specified otherwise, as used herein the words “a” and “an” and the like carry the meaning of “one or more” or “at least one.” The phrases “at least one,” “one or more,” “or,” and “and/or” are open-ended expressions that can be both conjunctive and disjunctive in operation. For example, each of the expressions “at least one of A, B and C,” “at least one of A, B, or C,” “one or more of A, B, and C,” “one or more of A, B, or C,” “A, B, and/or C,” and “A, B, or C” can mean A alone, B alone, C alone, A and B together, A and C together, B and C together, or A, B and C together. It is also to he noted that the terms “comprising,” “including,” and “having” can be used interchangeably.

It is to be understood that terms such as “left,” “right,” “top,” “bottom,” “front,” “rear,” “side,” “height,” “length,” “width,” “upper,” “lower,” “interior,” “exterior,” “inner,” “outer,” and the like that may be used herein, merely describe points of reference and do not necessarily limit embodiments of the described subject matter to any particular orientation or configuration. Furthermore, terms such as “first,” “second,” “third,” etc. merely identify one of a number of portions, components, points of reference, operations and/or functions as described herein, and likewise do not necessarily limit embodiments of the described subject matter to any particular configuration or orientation.

Embodiments of the disclosed subject matter can involve power cables for electric submersible pump (ESP) systems, and systems and methods thereof. More: specifically, embodiments of the disclosed subject matter can be comprised of a power cable, such as a tube encased power cable (TEPC), with multi-layer armor. Further, weight bearing power cables according to one or more embodiments of the disclosed subject matter may be “rigless” weight bearing power cables, meaning that the power cable is a self-supporting power cable, able to support its own weight and the weight of a pump and motor to which the power cable supplies power, with no need of further supporting structure.

Multi-layer armor, according to embodiments of the disclosed subject matter, is comprised of two or more longitudinally welded metal continuous tubes. The multi-layer armor can be provided around a cable core, comprised of a polymeric bedding that embeds electric conductor(s) and, optionally, hydraulic line(s), data cable(s), optical fiber(s), and/or stranded ropes optionally covered by respective protecting layer(s).

The multi-layer armor can comprise inner and outer longitudinally welded metal continuous tubes. Each inner and outer longitudinally welded metal continuous tube can be separately provided in the form of a foil longitudinally bent around, respectively, the polymeric bedding and the inner continuous tube (hereinafter both also being referred to as “the underlying layer”), and welded, to form a continuous tube having an inner diameter greater than the outer diameter of the underlying layer. After welding, each longitudinally welded metal continuous tube can be reduced in diameters so as to directly contact the underlying layer via a roll reducing technique.

The resultant power cable, produced via a unique method, can thus have a multi-layer armor made up of mechanically congruent metal continuous tubes that provide a unique way to “armor” or protect the cable core, and such that the so armored power cable can operate and support a predetermined load or weight and/or withstand the relatively harsh environment for ESP systems.

Generally, an ESP system comprises an electric submersible pump (ESP) which can be positioned in a well, for instance, at or toward the bottom of the well, at some km depth, and may be connected to a piping system to convey the production fluid (e.g., oil) to the surface. The motor of the ESP can be a three-phase alternate current (AC) motor powered by a power cable connected to an electric supply and regulation system on the surface of the well.

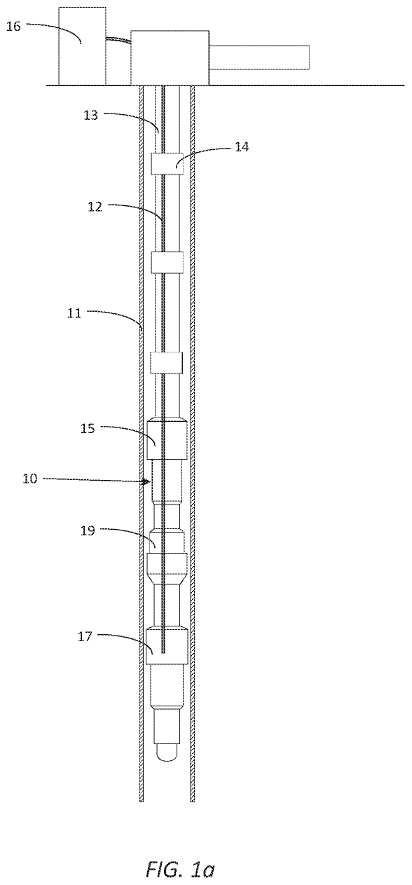

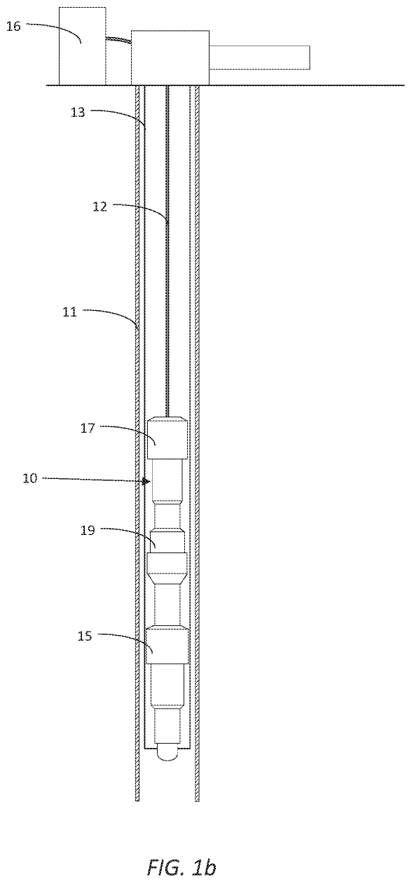

FIGS. 1a and 1b schematically show examples of electrical submersible pump (ESP) systems, wherein a well is shown having a casing 11 with a tubing 13 and an ESP system 10 provided therein.

According to FIGS. 1a and 1b , the ESP system 10 is comprised of an electric submersible pump (ESP) 15 (also known as down well pump, MVP). The electric submersible pump 15 may be secured to a lower end of the tubing 13, as in FIG. 1a, or at another element of the ESP system 10 (in this case, a seal section 19), as in FIG. 1b where the submersible pump 15 is the element of the ESP system 10 deeper in the well.

The electric submersible pump 15 can be operatively connected to a motor 17, optionally through a seal section 19, which may prevent well fluids from entering the motor 17, absorb thrust from pump 15, and/or equalize pressure between wellbore and motor 17.

Motor 17 is typically a three-phase alternate current (AC) motor configured to operate with voltages generally ranging from at or about 3 kV to at or about 5 kV. However, ESP systems according to embodiments of the disclosed subject matter can operate at higher voltages, depending, for example, on the well depth and/or temperature.

Power can be provided to the motor 17 from an electric supply and regulation system (ESRS) 16 (on the surface), via a power cable 12.

The ESRS 16 can provide a voltage higher than that required by the motor 17, for instance, to compensate for a voltage drop in the power cable 12, which may be significant in deep installations (e.g., deeper than 1.5 km) and, therefore, can require relatively long power cables. As a non-limiting example, power cables according to one or more embodiments of the disclosed subject matter can have a length of at or about km.

Power cables according to embodiments of the disclosed subject matter can be configured to feed power to the ESP systems, more particularly, to a motor of the ESP system. Further, power cables according to embodiments of the disclosed subject matter can be configured to transport alternating current (AC) at medium voltage (MV) to the motor. Medium voltage may be defined as voltage having an amplitude of from at or about 3 kV to at or about 8 kV (e.g., at 40 Hz, 50 Hz, or 60 Hz).

In the case of FIG. 1a, the power cable 12 may be secured to the tubing 13 by fasteners 14, in form of bands, clamps, or the like, to limit movement of the power cable 12 in the casing 11.

While in the deployment of FIG. 1a, the tubing 13 (which conveys the well extraction product to the surface) supports the ESP system 10, in the deployment of FIG. 1b, the power cable 12. connected to the motor 17, is the supporting element of the ESP system 10. It should be noted that such supporting function of the power cable 12 could be exerted also in an ESP system having an element disposition like that of FIG. 1a.

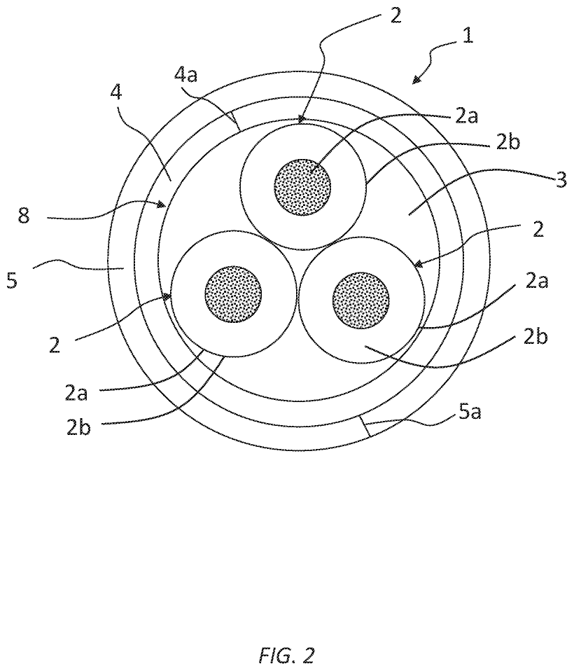

FIGS. 2-4 are cross-sectional schematic views of power cables according to various embodiments of the disclosed subject matter. These views are merely examples of embodiments of the disclosed subject matter and are not intended to represent the only embodiments.

FIG. 2 is a cross-sectional schematic view of a power cable 1 according to one or more embodiments of the present disclosure.

The power cable 1, in this example, is substantially circular in cross-section, with an outer diameter. As a non-limiting exemplary range, the outer diameter of the power cable 1 may be from at or about 25 mm (about 0.98 inches) to at or about 33 mm (about 1.378 inches).

As a more specific, non-limiting example, the outer diameter of power cable 1 may be at or about 29.36 mm (about 1.156 inches) (nominal), and a wall thickness of about 1.24 mm (about 0.049 inches) for each of the inner tube 4 and outer tube 5. The radius of curvature of bending neutral axis (RBNA) can be at or about 703 mm (about 27.7 inches), the radius of curvature of bending block can be at or about 688 mm (about 27.1 inches), and a minimum diameter of spool drum can be at or about 1377 mm (about 54.2 inches), with a mid-wall thickness strain ε of about 2.00% (ε=(D−t)/2×RBNA, wherein D is the cable outer diameter and t is the wall thickness for each of the inner tube 4 and outer tube 5. The foregoing numerical values are non-limiting examples.

The power cable 1 is comprised of three insulated conductors 2, a polymeric bedding 3, an inner steel-based continuous tube 4, and an outer steel-based continuous tube 5. The insulated conductors 2 and the polymeric bedding 3 are parts of a cable core 8.

Each insulated conductor 2 can be configured to carry power and can be comprised of a conductor 2a and an insulating system 2b that circumscribes the conductor 2a. As non-limiting examples, each insulated conductor 2 may have a voltage rating of 5000 V AC and/or an insulation resistance at 20° C. (conductor to tube) of 1576 MΩ-km (5171 MΩ-kft) minimum.

The conductor 2a can be made of a metal, for instance, aluminum or copper or both. Further, the conductor 2a may be in the form of a rod or twisted wires. As a non-limiting example, the conductor 2a may be a #4 AWG (21.2 mm²) solid tinned copper core conductor with an outer diameter of at or about 5.18 mm (about 0.204 inches) (nominal). The conductor 2a of the insulated conductor 2 may have a DC resistance at 20° C. of at or about 0.87 ohms/km (about 0.27 ohms/1000 ft.) maximum, for instance.

The insulating system 2b can be made of three extruded polymeric layers, for instance, an inner semiconductive layer, an insulating layer, and an outer semiconductive layer (not expressly shown). In one or more embodiments, all of the layers of the insulating system 2b can be made of ethylene propylene rubber (EPR), and charged with a conductive filler, such as carbon black, for the semiconductive layers. The insulating system 2b, as a non-limiting example, can have an outer diameter of at or about 9.4 mm (about 0.370 inches) (i.e., an outer diameter of the outer semiconductive layer).

The polymeric bedding 3 generally embeds the insulated conductors 2, which are stranded one another. For example, the polymeric bedding 3 can be made of ethylene propylene rubber (EPR) or of cross-linked polyethylene (XLPE).

The outer surface defining the circumference of the cable core 8 is in direct contact with the inner steel-based tube 4. In an embodiment where the inner steel-based tube 4 represents multiple inner steel-based tubes, the outer surface of the cable core 8 is in direct contact with only the innermost inner steel-based tube 4.

The cable core 8 may have an outer diameter of at or about 24.4 mm (about 0.960 inches) (nominal), this numerical value being a non-limiting example.

The inner steel-based tube 4 is continuous, meaning that the inner steel-based tube 4 does not expose underlying layers, particularly the cable core 8. Further, the inner steel-based tube 4 has an inner surface that is in direct contact with the outer surface of the cable core 8. Accordingly, the inner diameter of the inner steel-based tube 4 is substantially the same as the outer diameter of the cable core 8.

The inner steel-based tube 4 has a first welding line 4a. As shown in FIG. 2. the inner steel-based tube 4 circumscribes and is in direct contact with the cable core 8 such that no gap exists between the inner steel-based tube 4 and the cable core 8, even in correspondence to the first welding line 4a.

The inner steel-based tube 4 can be made of stainless steel or of a chemical resistant steel alloy, such as an Incoloy™ alloy (e.g., Incoloy™ 825). In the case of stainless steel, the inner steel-based tube 4 can be made of an austenitic stainless steel, such as 316L, as a non-limiting example.

Optionally, the inner steel-based tube 4 can be comprised of a plurality of inner steel-based tubes, for instance, two or more inner steel-based tubes, which are concentrically arranged respect to each other. In such a case, the inner steel-based tubes 4 may be made from the same material or, alternatively, the inner steel-based. tubes 4 may be made from a different material from the other (or others)inner steel-based tube(s) 4.

In the embodiment of FIG. 2, the inner steel-based tube 4 has a wall thickness that is substantially the same as a wall thickness of the outer steel-based tube 5. As an example, the inner steel-based tube 4 may have a wall thickness of at or about 1.24 mm (about 0.049 inches). Further, as non-limiting example, the inner steel-based tube 4 may have an outer diameter of at or about 26.87 mm (1.058 inches) (nominal).

The yield strength of the inner steel-based tube 4 may depend upon the material from which it is made. For example, in a case where the inner steel-based tube 4 is made of stainless steel 316L, the inner steel-based tube 4 may have an average yield strength (YS) of from at or about 0.757 MPa (109,800 psi) at 204° C. to at or about 0.841 MPa (122,000 psi) at 20° C. As another example, in a case where the inner steel-based tube 4 is made of Incoloy™ 825, the inner steel-based tube 4 may have a typical yield strength (YS) of from at or about 0.807 MPa (117,000 psi) at 204° C. to at or about 0.896 MPa (130,000 psi) at 20° C. The foregoing numerical values are non-limiting examples.

The outer steel-based tube 5, which forms the outermost surface or layer of the power cable 1, is continuous, meaning that the outer steel-based tube 5 does not expose underlying layers, particularly the inner steel-based tube 4. Further, the outer steel-based tube 5 has an inner surface that is in direct contact with the outer surface of the inner steel-based tube 4. Accordingly, the inner diameter of the outer steel-based tube 5 may be substantially the same as the outer diameter of the inner steel-based tube 4.

The outer steel-based tube 5 has a second welding line 5a. As shown in FIG. 2, the outer steel-based tube 5 circumscribes and is in direct contact with the inner steel-based tube 4 such that no gap exists between the outer steel-based tube 5 and the inner steel-based tube 4, even in correspondence to the second welding line 5a.

In the embodiment of FIG. 2, the first welding line 4a and the second welding line 5a are diametrically opposed. In an embodiment where the inner steel-based tube 4 can be comprised of a plurality of inner steel-based tubes, the first welding lines 4a of each tube can be radially displaced relative to one another.

The material of the outer steel-based tube 5 may be selected according to the operation environment for the power cable 1. For example, in a challenging environment where, for example, aggressive chemicals like H₂S, halides, brines such as CaCl₂ and ZnBr, and/or high-pressure steam (from steam-assisted gravity drainage, SAGD) are present, the outer steel-based tube 5 can be made from a chemical resistant steel alloy, such as Incoloy™ 825. Alternatively, the outer steel-based tube 5 may be stainless steel, such as an austenitic stainless steel like 316L. Further, in one or more embodiments, the material of the outer steel-based tube 5 may be different from the material of the inner steel-based tube 4. For example, the outer steel-based tube 5 may be made of Incoloy™ 825 and the inner steel-based tube 4 may be made of stainless steel 316L.

The outer steel-based tube 5 may have a wall thickness of at or about 1.24 mm (about 0.049 inches), and an outer diameter of at or about 29.36 mm (about 1.156 inches) (nominal), as alluded to above. Further, the outer steel-based tube 5 can have a typical yield strength (YS) of from at or about 0.807 MPa (117,000 psi) at 204° C. to at or about 0.896 MPa (130,000 psi) at 20° C., The foregoing numerical values are non-limiting examples.

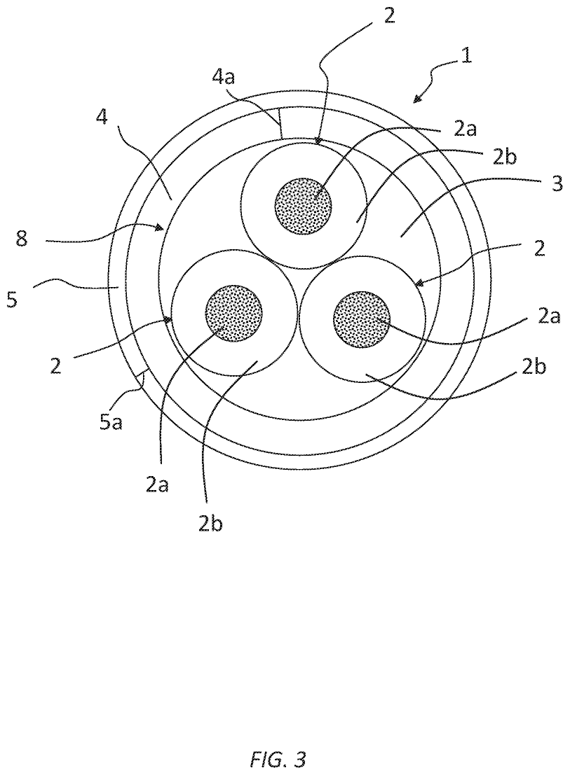

FIG. 3 is a cross-sectional schematic view of a power cable 1 according to another embodiment of the present disclosure.

The power cable 1 shown in FIG. 3 is similar to the power cable 1 of FIG. 2, but notably has an inner steel-based tube 4 with a thickness greater than a thickness of the outer steel-based tube 5.

For instance, the outer steel-based tube 5 may have a wall thickness of at or about 0.89 mm (about 0.035 inches), and the inner steel-based tube 4 may have a wall thickness of at or about 1.65 mm (about 0.065 inches). Further, the inner steel-based tube 4 may have an outer diameter of at or about 27.69 mm (about 1.09 inches (nominal), and a yield strength (YS) of from at or about 0.757 MPa (109,800 psi) at 204° C. to at or about 0.841 MPa (122,000 psi) at 20°, for instance. However, the foregoing numerical values are non-limiting examples.

In the embodiment of FIG. 3, the first welding line 4a and the second welding line 5a are radially displaced relative to one another.

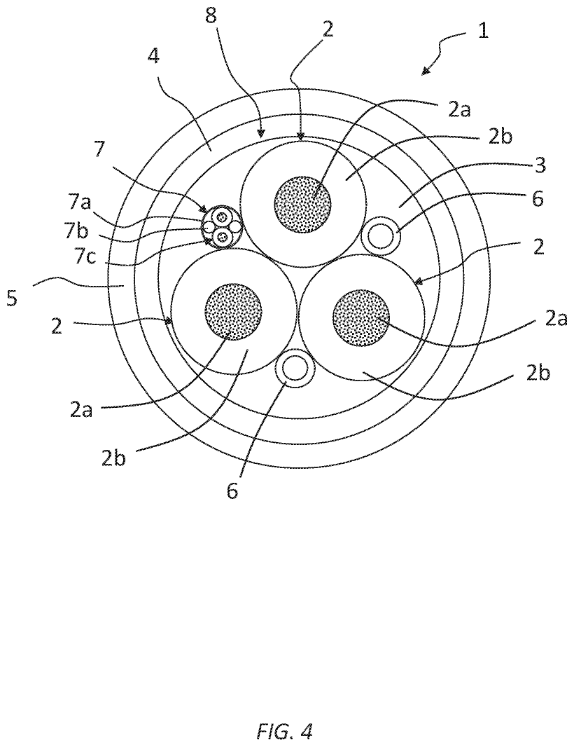

FIG. 4 is a cross-sectional schematic view of a power cable 1 according to yet another embodiment of the present disclosure.

The power cable 1 of FIG. 4 is similar to the power cables of FIG. 2, but notably additional includes, as part of the cable core 8, one or more fluid tubes 6 (FIG. 4 shows two tubes) and one or more control cables 7 (FIG. 4 shows one control cable). The fluid tube 6 and the control cable 7 can be embedded in the polymeric bedding 3. For example, as shown in FIG. 4, the fluid tube 6 and the control cable 7 can be stranded into the interstices between the insulated conductors 2. Each fluid tube 6 can be a metallic, for instance, steel-based tube.

The control cable 7 can be configured to handle control signaling for the ESP 15. As a non-limiting example, the control cable 7 and can be comprised of a protective sheath 7a, one or more drain wires 7b (suitable for stabilizing the cable configuration), and a pair of electric metal conductors surrounded by respective insulating sheaths 7c. The protective sheath 7a may be comprised of one or more layers made of metal like aluminum and/or polymer materials like a fluorine-containing polymer. In an embodiment, the power cable 1 of FIG. 4 can have an inner steel-based tube 4 with a thickness greater than a thickness of the outer steel-based tube 5.

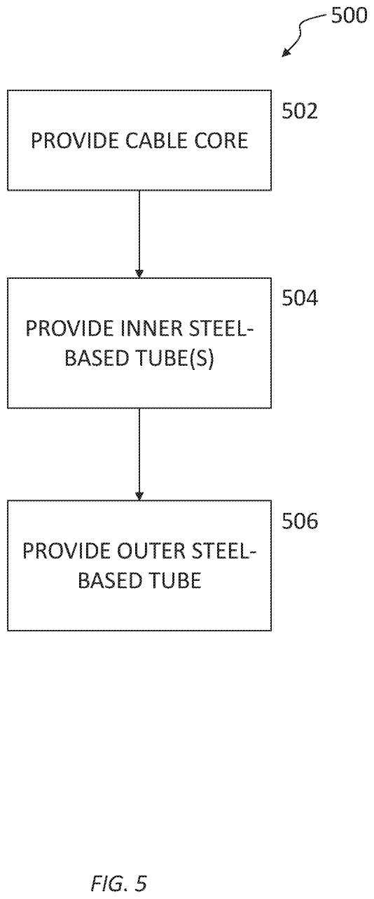

FIG. 5 is a flow chart of a method 500 according to one or more embodiments of the disclosed subject matter.

Method 500 can be representative of a method of manufacturing power cables according to one or more embodiments of the disclosed subject matter. Thus, optionally, the operations associated with the method 500 can be performed all at once or in a sequence to make such power cable.

Generally, the method 500 can be comprised of providing, at block 502, a cable core, such as described herein; providing, at block 504, an inner steel-based continuous tube, such as described herein; and providing, at block 506. an outer steel-based continuous tube, such as described herein.

In the case of block 504 corresponding to an operation to make a power cable according to embodiments of the disclosed subject matter, the inner steel-based tube can be provided in the form of a foil, longitudinally bent around the cable core, and welded, at opposite edge portions, to form a continuous inner steel-based tube having an inner diameter greater than the outer diameter of the underlying cable core. The welding (e.g., via tungsten inert gas, TIG, welding) of opposite edge portions of the longitudinally bent foil can be via a side by side arrangement for the opposite edges. After the welding, the continuous inner steel-based tube can be reduced in diameters, via a roll reducing technique, so as to make its inner diameter directly contact the underlying cable core. The operations at block 504 may be repeated in a case where multiple inner steel-based tubes are implemented, with successive inner steel-based tubes having an inner diameter greater than the outer diameter of the underlying tube, being roll-reduced to contact the immediately axially underlying inner steel-based tube. Roll reducing each successive inner steel-based tube to directly contact the underlying inner steel-based tube can make the inner continuous steel-based tubes mechanically congruent.

In the case of block 506 corresponding to an operation to make a power cable according to embodiments of the disclosed subject matter, the outer steel-based tube can be provided in the form of a foil, longitudinally wrapped around the already diameter-reduced continuous inner steel-based tube, and welded, at opposite edge portions, to form a continuous outer steel-based tube having an inner diameter greater than the outer diameter of the underlying continuous inner steel-based tube. After the welding, carried out in an analogous manner as for the inner steel-based tube, the continuous outer steel-based tube can be reduced in diameters, via the roll reducing technique, so as to directly contact the underlying continuous inner steel-based tube. As noted above, roll reducing the outer steel-based tube can make the inner and outer continuous tubes mechanically congruent so as to act as a whole to support the weights of the power cable and the ESP, but without stressing the continuous tubes to an extent potentially exceeding their tensile strength and bringing to a weakening or rupture thereof.

Having now described embodiments of the disclosed subject matter, it should be apparent to those skilled in the art that the foregoing is merely illustrative and not limiting, having been presented by way of example only. Thus, although particular configurations have been discussed and illustrated herein, other configurations can be and are also employed. Further, numerous modifications and other embodiments (e.g., combinations, rearrangements, etc.) are enabled by the present disclosure and are contemplated as falling within the scope of the disclosed subject matter and any equivalents thereto. Features of the disclosed embodiments can be combined, to rearranged, omitted, etc., within the scope of described subject matter to produce additional embodiments. Furthermore, certain features may sometimes be used to advantage without a corresponding use of other features. Accordingly, Applicant intends to embrace all such alternatives, modifications, equivalents, and variations that are within the spirit and scope of the present disclosure. Further, it is therefore to be understood that within the scope of the appended claims, the disclosure may be practiced otherwise than as specifically described herein.

1. A weight-bearing three-phase power cable (1) for an electric submersible pump (ESP), comprising:
a core (8) having an outer diameter and comprising three insulated conductors (2) substantially embedded in a polymeric bedding (3); and
a multi-layered armor comprising:
an inner steel-based continuous tube (4) surrounding and in direct contact with the core (8), and
an outer steel-based continuous tube (5) surrounding and in direct contact with the inner steel-based continuous tube (4),
wherein the outer steel-based continuous tube (5) forms an outer wall of the power cable (1).

2. The power cable according to claim 1 which is configured to support its own weight and the weight of the ESP when coupled thereto.

3. The power cable according to claim 1,
wherein the inner steel-based continuous tube (4) is in direct contact with the core (8).
wherein the outer steel-based continuous tube (5) is in direct contact with first inner steel-based continuous tube (4), and
wherein the inner steel-based continuous tube (4) and the outer steel-based continuous tube (5) are mechanical congruent with each other.

4. The power cable according to claim 1, wherein the outer steel-based continuous tube (5) has an outer diameter of in a range from at or about 25 mm to at or about 35 mm.

5. The power cable according to claim 1,
wherein the outer steel-based continuous tube (5) is made of a material selected from chemical resistant steel alloy and a stainless steel, and
wherein the inner steel-based continuous tube (4) is made of a material selected from chemical resistant steel alloy and a stainless steel.

6. The power cable according to claim 5, wherein the outer steel-based continuous tube (5) and the inner steel-based continuous tube (4) are made of different steel-based materials.

7. The power cable according to claim 6,
wherein the outer steel-based continuous tube is made of the chemical resistant steel alloy, and
wherein the inner steel-based continuous tube (4) is made of the stainless steel.

8. The power cable according to claim 1, wherein the inner steel-based continuous tube (4) has a first welding line (4a) and the outer steel-based continuous tube (5) has a second welding line (5a).

9. The power cable according to claim 8, wherein the first welding line (4a) and the second welding line (5a) are diametrically opposed.

1. power cable according to claim 1, wherein the core (8) comprises one or more of a fluid tube (6) and a control cable (7).

11. The power cable according to claim 1, wherein a thickness of the outer steel-based continuous tube (5) is the same as a thickness of the inner steel-based continuous tube (4).

12. The power cable according to claim 11, wherein the thickness of the inner steel-based continuous tube (4) is greater than the thickness of the outer steel-based continuous tube (5).

13. A method of providing a three-phase alternating current (AC) medium voltage (MV) weight-bearing electric submersible pump (ESP) cable (1), the method comprising:
providing a cable core (8) with an outer diameter and comprising three insulated electrical conductors (2) embedded in a polymeric bedding (3);
providing around the cable core (8) a. first steel based foil;
longitudinally folding the first steel based foil and welding opposite edges thereof to form an inner steel-based continuous tube (4) having an inner diameter greater the core outer diameter and an outer diameter;
rolling down the inner steel-based continuous tube (4) to bring it in direct contact with the cable core (8);
providing around the inner steel-based continuous tube (4) a second steel based foil;
longitudinally folding the second steel based foil and welding opposite edges thereof to form an outer steel continuous tube (5) having an inner diameter greater the inner steel-based continuous tube and an outer diameter; and
rolling down the outer steel-based continuous tube (5) to bring it in direct contact and mechanically congruent with the inner steel-based continuous tube (4).

14. Electric submersible pump (ESP) system comprising an electric submersible pump (15), a three-phase alternate current motor (17) and a power cable (12), the electric submersible pump (15), the three-phase AC motor (17) and the power cable (12) being operatively connected, wherein the power cable (12) is a weight-bearing three-phase power cable (12) comprising a core (8) having an outer diameter and comprising three insulated conductors (2) substantially embedded in a polymeric bedding (3); and a multi-layered armor comprising an inner steel-based continuous tube (4) surrounding and in direct contact with the core (8), and an outer steel-based continuous tube (5) surrounding and in direct contact with the inner steel-based continuous tube (4), wherein the inner steel-based continuous tube (4) and the outer steel-based continuous tube (5) are mechanical congruent with each other.
